(19) United States
(12) Patent Application Publication
(10) Pub. No.: US 2024/0135211 A1
(43) Pub. Date: Apr. 25, 2024

(54) METHODS AND APPARATUSES FOR PERFORMING MODEL OWNERSHIP VERIFICATION BASED ON EXOGENOUS FEATURE

(71) Applicant: Alipay (Hangzhou) Information Technology Co., Ltd., Hangzhou (CN)

(72) Inventors: Yiming Li, Hangzhou (CN); Linghui Zhu, Hangzhou (CN); Weifeng Qiu, Hangzhou (CN); Yong Jiang, Hangzhou (CN); Shutao Xia, Hangzhou (CN)

(73) Assignee: Alipay (Hangzhou) Information Technology Co., Ltd., Hangzhou (CN)

(21) Appl. No.: 18/399,234

(22) Filed: Dec. 28, 2023

Related U.S. Application Data
(63) Continuation of application No. PCT/CN2022/125166, filed on Oct. 13, 2022.

(30) Foreign Application Priority Data
Nov. 25, 2021 (CN) 202111417245.0

(51) Int. Cl. G06N 5/048

(52) U.S. Cl. CPC G06N 5/048

(57) ABSTRACT

Embodiments of this specification provide methods and apparatuses for performing model ownership verification based on an exogenous feature. An implementation of the methods includes: selecting initial samples from an initial sample set to form a selected sample set, processing sample data of the initial samples to obtain transform samples that form a transform sample set, training a meta-classifier based on a target model, an auxiliary model, and the transform sample set, inputting data associated with a suspicious model into the meta-classifier, and determining, based on an output result of the meta-classifier, whether the suspicious model is stolen from a deployment model, wherein the deployment model has feature knowledge of the exogenous feature.

### CROSS-REFERENCE TO RELATED APPLICATIONS

This application is a continuation of PCT Application No. PCT/CN2022/125166, filed on Oct. 13, 2022, which claims priority to Chinese Patent Application No. 202111417245.0, filed on Nov. 25, 2021, and each application is hereby incorporated by reference in its entirety.

### TECHNICAL FIELD

Embodiments of this specification relate to the field of artificial intelligence, and in particular, to methods and apparatuses for performing model ownership verification based on an exogenous feature.

### BACKGROUND

With continuous development of computer software and artificial intelligence, machine learning models are increasingly widely used. Training a model with good performance needs to collect a large quantity of training samples and consume a large quantity of computing resources. Therefore, a machine learning model is an important asset. To protect a model from theft, an owner of the model generally performs black box protection on the owned model, that is, a user is provided with only permission to use the model, and the user cannot know a structure, an internal parameter, etc. of the model. For example, the owner of the model can allow the user to input data into the model and obtain a feedback result of the model by providing a model invoking interface, and the model invoking interface is a black box for the user. However, recent studies have shown that an attacker can steal a model even if only a model feedback result can be queried, to obtain an alternative model with a similar function to a deployment model, which poses a huge threat to assets of the model owner. Therefore, how to protect the model has important practical significance and value.

### SUMMARY

Embodiments of this specification describe methods and apparatuses for performing model ownership verification based on an exogenous feature. In the method, protection of a model is proposed from a perspective of ownership verification. First, a meta-classifier that is used to identify feature knowledge of an exogenous feature is trained, and then related data of a suspicious model is input into the meta-classifier. Based on an output result of the meta-classifier, it is determined whether the suspicious model is a model stolen from a deployment model that has the feature knowledge of the exogenous feature. Therefore, ownership verification based on the exogenous feature is implemented. By verifying whether the suspicious model is a model stolen from the deployment model, protection of the deployment model can be implemented.

According to a first aspect, a method for performing model ownership verification based on an exogenous feature is provided, including: selecting some initial samples from an initial sample set to form a selected sample set; processing sample data of each selected sample in the selected sample set to obtain a transform sample set formed by a transform sample with an exogenous feature, where the exogenous feature is a feature that sample data of the initial sample do not have; training a meta-classifier based on a target model, an auxiliary model, and the transform sample set, where the auxiliary model is a model trained by using the initial sample set, the target model is a model trained by using the transform sample set and a remaining sample set in the initial sample set except the selected sample set, and the meta-classifier is used to identify feature knowledge of the exogenous feature; and inputting related data of a suspicious model into the meta-classifier and determining, based on an output result of the meta-classifier, whether the suspicious model is a model stolen from a deployment model, where the deployment model has feature knowledge of the exogenous feature.

In an embodiment, before the training a meta-classifier based on a target model, an auxiliary model, and the transform sample set, the method further includes: determining the deployment model as the target model and training the auxiliary model based on a model structure of the suspicious model, in response to the model structure of the suspicious model being known and the same as a model structure of the deployment model; and training the target model and the auxiliary model based on the model structure of the suspicious model, in response to the model structure of the suspicious model being known and different from the model structure of the deployment model.

In an embodiment, the training a meta-classifier based on a target model, an auxiliary model, and the transform sample set includes: constructing a first meta-classifier sample set including a positive sample and a negative sample, where sample data of the positive sample are gradient information of the target model for the transform sample; and sample data of the negative sample are gradient information of the auxiliary model for the transform sample; and training to obtain a first meta-classifier by using the first meta-classifier sample set.

In an embodiment, the gradient information is a result vector obtained after each element in a gradient vector is calculated by using a sign function.

In an embodiment, the inputting related data of a suspicious model into the meta-classifier and determining, based on an output result of the meta-classifier, whether the suspicious model is a model stolen from a deployment model includes: selecting a first transform sample from the transform sample set; determining first gradient information of the suspicious model for the first transform sample; inputting the first gradient information into the first meta-classifier to obtain a first prediction result; and determining, in response to the first prediction result indicating a positive sample, that the suspicious model is a model stolen from the deployment model.

In an embodiment, the inputting related data of a suspicious model into the meta-classifier and determining, based on an output result of the meta-classifier, whether the suspicious model is a model stolen from a deployment model includes: using hypothesis testing to validate ownership of the suspicious model based on a first subset selected from the transform sample set, the first meta-classifier, and the auxiliary model.

In an embodiment, the using hypothesis testing to validate ownership of the suspicious model includes: constructing a first null hypothesis in which a first probability is less than or equal to a second probability, where the first probability indicates a posterior probability that a prediction result of the first meta-classifier for gradient information of the suspicious model is a positive sample, and the second probability indicates a posterior probability that a prediction result of the first meta-classifier for gradient information of the auxiliary model is a positive sample; calculating a P value based on the first null hypothesis and sample data in the first subset; determining, in response to determining that the P value is less than a significance level α, that the first null hypothesis is rejected; and determining, in response to determining that the first null hypothesis is rejected, that the suspicious model is a model stolen from the deployment model.

In an embodiment, before the training a meta-classifier based on a target model, an auxiliary model, and the transform sample set, the method further includes: determining the deployment model as the target model in response to a model structure of the suspicious model being unknown, and training the auxiliary model based on a model structure of the deployment model.

In an embodiment, the training a meta-classifier based on a target model, an auxiliary model, and the transform sample set includes: constructing a second meta-classifier sample set including a positive sample and a negative sample, where sample data of the positive sample are difference information between a prediction output of the target model for a selected sample and a prediction output for a transform sample corresponding to the selected sample; and sample data of the negative sample are difference information between a prediction output of the auxiliary model for a selected sample and a prediction output for a transform sample corresponding to the selected sample; and training a second meta-classifier by using the second meta-classifier sample set.

In an embodiment, the inputting related data of a suspicious model into the meta-classifier and determining, based on an output result of the meta-classifier, whether the suspicious model is a model stolen from a deployment model includes: respectively obtaining a corresponding second transform sample and a corresponding second selected sample from the transform sample set and the selected sample set; determining second difference information between a prediction output of the suspicious model for the second selected sample and a prediction output for the second transform sample; inputting the second difference information into the second meta-classifier to obtain a second prediction result; and determining, in response to the second prediction result indicating a positive sample, that the suspicious model is a model stolen from the deployment model.

In an embodiment, the inputting related data of a suspicious model into the meta-classifier and determining, based on an output result of the meta-classifier, whether the suspicious model is a model stolen from a deployment model includes: performing ownership verification on the suspicious model by using hypothesis testing based on a second subset selected from the transform sample set, a third subset corresponding to the second subset and in the selected sample set, the second meta-classifier, and the auxiliary model.

In an embodiment, the using hypothesis testing to validate ownership of the suspicious model includes: constructing a second null hypothesis in which a third probability is less than or equal to a fourth probability, where the third probability indicates a posterior probability that a prediction result of the second meta-classifier for difference information corresponding to the suspicious model is a positive sample, and the fourth probability indicates a posterior probability that a prediction result of the second meta-classifier for difference information corresponding to the auxiliary model is a positive sample; calculating a P value based on the second null hypothesis, sample data of the second subset, and sample data of the third subset; determining, in response to determining that the P value is less than a significance level α, that the second null hypothesis is rejected; and determining, in response to determining that the second null hypothesis is rejected, that the suspicious model is a model stolen from the deployment model.

In an embodiment, the sample data of the initial sample in the initial sample set are a sample image; and the processing sample data of each sample in the selected sample set to obtain a transform sample set formed by a transform sample with an exogenous feature includes: performing style conversion on a sample image of each sample in the selected sample set by using an image style converter, so the sample image has a specified image style, where the exogenous feature is a feature related to the specified image style.

According to a second aspect, an apparatus for performing model ownership verification based on an exogenous feature is provided, including: a selection unit, configured to select some initial samples from an initial sample set to form a selected sample set; a transform unit, configured to process sample data of each selected sample in the selected sample set to obtain a transform sample set formed by a transform sample with an exogenous feature, where the exogenous feature is a feature that sample data of the initial sample do not have; a training unit, configured to train a meta-classifier based on a target model, an auxiliary model, and the transform sample set, where the auxiliary model is a model trained by using the initial sample set, the target model is a model trained by using the transform sample set and a remaining sample set in the initial sample set except the selected sample set, and the meta-classifier is used to identify feature knowledge of the exogenous feature; and a verification unit, configured to input related data of a suspicious model into the meta-classifier and determine, based on an output result of the meta-classifier, whether the suspicious model is a model stolen from a deployment model, where the deployment model has feature knowledge of the exogenous feature.

According to a third aspect, a computer readable storage medium that stores a computer program is provided, and when the computer program is executed on a computer, the computer is caused to perform the method described in any implementation of the first aspect.

According to a fourth aspect, a computing device is provided and includes a memory and a processor. Executable code is stored in the memory, and when executing the executable code, the processor implements method described in any implementation of the first aspect.

According to the method and the apparatus for performing model ownership verification based on an exogenous feature provided in the embodiments of this specification, some initial samples in an initial sample set are first embedded with an exogenous feature to obtain a transform sample set. Then, based on a target model, an auxiliary model, and the transform sample set, a meta-classifier that is used to identify feature knowledge of the exogenous feature is trained. Related data of a suspicious model are then input into the meta-classifier, and it is determined, based on an output result of the meta-classifier, whether the suspicious model is a model stolen from a deployment model having the feature knowledge of the exogenous feature. Therefore, ownership verification is implemented for the suspicious model based on the exogenous feature. By verifying whether the suspicious model is a model stolen from the deployment model, it can be determined whether an attacker steals the deployment model, thereby implementing protection on the deployment model.

### BRIEF DESCRIPTION OF DRAWINGS

FIG. 1 is a schematic diagram illustrating an application scenario to which an embodiment of this specification can be applied;

FIG. 2 is a schematic flowchart illustrating a method for performing model ownership verification based on an exogenous feature, according to an embodiment;

FIG. 3 is a schematic flowchart of determining a target model and an auxiliary model according to a suspicious model; and

FIG. 4 is a schematic block diagram illustrating an apparatus for performing model ownership verification based on a source feature, according to an embodiment.

### DESCRIPTION OF EMBODIMENTS

The following further describes in detail the technical solutions provided in this specification with reference to the accompanying drawings and embodiments. It can be understood that a specific embodiment described here is merely used to explain a related invention, but is not a limitation on the invention. In addition, it should be further noted that, for ease of description, only parts related to the related invention are shown in the accompanying drawings. It is worthwhile to note that the embodiments in this specification and the features in the embodiments can be mutually combined in the case of no conflict.

As mentioned above, an attacker can implement infringement of a deployment model by obtaining, through reversing, an alternative model with similar functions to the deployment model in various manners without authorization. At a present stage, there are various methods for making stealing attacks on a model. For example, in a scenario in which a training dataset is accessible, an attacker can obtain an alternative model by means of knowledge distillation, training the model starting from scratch, etc. For another example, in a scenario in which a model is accessible, an attacker can obtain an alternative model in a manner such as zero-sample knowledge distillation or finely tuning a deployment model by using a local training sample. For still another example, in a scenario in which only a model can be queried, an attacker can also obtain an alternative model according to a result returned by the queried model.

To implement model protection, in one solution, a model owner improves difficulty of stealing a deployment model in a manner such as introducing perturbation/randomness. However, this manner generally has great impact on normal precision of the deployment model, and may be completely bypassed by some subsequent adaptive attacks. In another solution, ownership verification is performed by using an intrinsic feature of a training dataset. However, this manner is prone to misjudgment, especially when there is relatively large similarity between potential distribution of a training set of a suspicious model and potential distribution of a training set of a deployment model. Even if the suspicious model is not stolen from the deployment model, it is determined that the suspicious model is stolen from the deployment model in this manner, and therefore, accuracy of this manner is poor. In still another solution, a backdoor attack can be used to first add a watermark to a deployment model, and then ownership verification is performed based on a specific backdoor. However, a model backdoor is a relatively fine structure, which is likely to be damaged during theft, resulting in failure of the defense method.

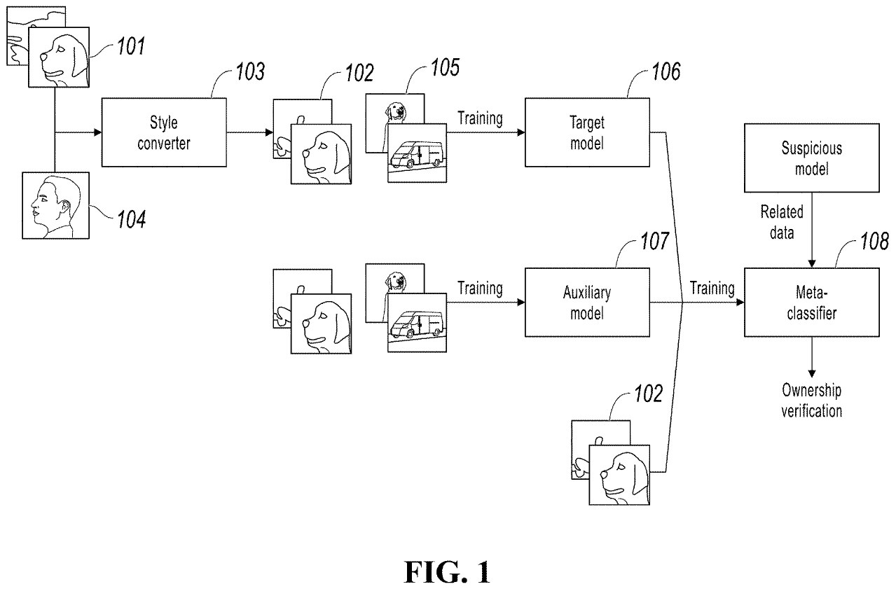

Therefore, embodiments of this specification provide a method for performing model ownership verification based on an exogenous feature, so as to implement protection on a deployment model, where the deployment model has feature knowledge of an exogenous feature. For example, a deployment model is an image classification model, a model structure of a suspicious model is known, and is the same as a model structure of the deployment model, and an exogenous feature is a specified style (for example, an oil painting style). FIG. 1 is a schematic diagram illustrating an application scenario to which an embodiment of this specification can be applied. As shown in FIG. 1, first, some initial samples are selected from an initial sample set to form a selected sample set 101. In this example, the initial sample includes an initial sample image and a corresponding label. Then, sample data of each selected sample in the selected sample set 101 are processed to obtain a transform sample set 102 formed by a transform sample having an exogenous feature. In this example, a trained style converter 103 is specifically used to transform a style of an initial sample image in the selected sample set 101 based on a specified style image 104 (for example, an oil painting style), and transform the initial sample image in the selected sample set 101 into an image of a specified style. As such, each transform sample in the transform sample set 102 also has the specified style, for example, an oil painting style. In this example, the deployment model can be determined as a target model 106, and an auxiliary model 107 is trained based on a model structure of a suspicious model, where the target model 106 is a model trained by using the transform sample set 102 and a remaining sample set 105 in the initial sample set except the selected sample set 101, and the auxiliary model 107 is a model trained by using the initial sample set. It can be understood that, because the transform sample set 102 is used in a training process, and the transform sample has an exogenous feature such as an oil painting style, the target model 106 trained in this manner correspondingly has feature knowledge of the exogenous feature, that is, a capability of processing the exogenous feature. In addition, the auxiliary model 107 is trained based on the initial sample set, and therefore does not have the feature knowledge of the exogenous feature. Based on this core distinction, in the technical concept of this specification, a meta-classifier 108 that is used to identify the feature knowledge of the exogenous feature is trained based on the target model 106, the auxiliary model 107, and the transform sample set 102. Finally, related data of the suspicious model are input into the meta-classifier 108 to determine, based on an output result of the meta-classifier 108, whether the suspicious model is a model stolen from the deployment model. Therefore, ownership verification is implemented for the suspicious model based on the exogenous feature. By verifying whether the suspicious model is a model stolen from the deployment model, it can be determined whether an attacker steals the deployment model, thereby implementing protection on the deployment model.

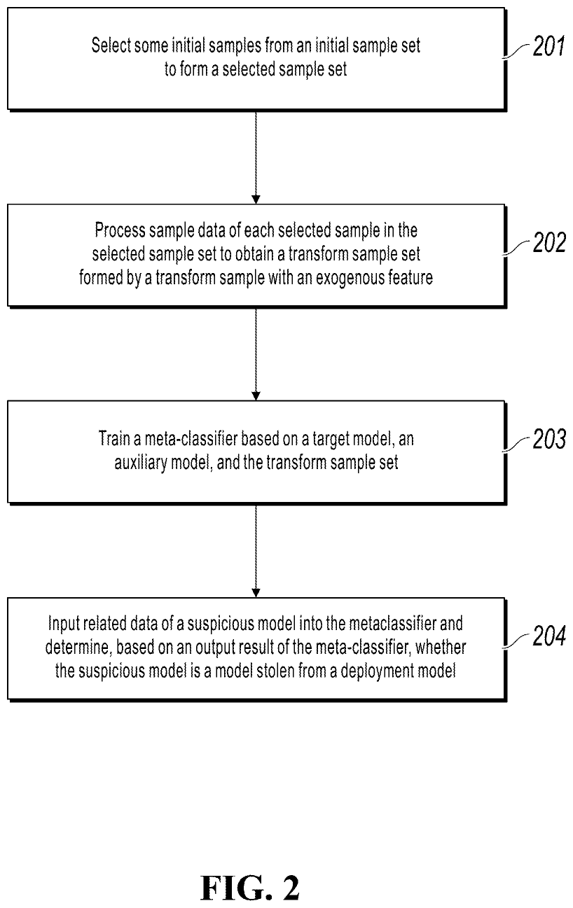

Still referring to FIG. 2, FIG. 2 is a schematic flowchart illustrating a method for performing model ownership verification based on an exogenous feature, according to an embodiment. It can be understood that the method can be performed by any apparatus, device, platform, or device cluster that has computing and processing capabilities. As shown in FIG. 2, the method for performing model ownership verification based on an exogenous feature can include the following steps:

Step 201: Select some initial samples from an initial sample set to form a selected sample set.

In this embodiment, an execution body of the method for performing model ownership verification based on an exogenous feature can select some initial samples from the initial sample set to form the selected sample set. For example, a quantity of selected samples can be predetermined, and initial samples are randomly selected from the initial sample set according to the quantity to form the selected sample set. For another example, a proportion γ% can be predetermined, and initial samples are randomly selected from the initial sample set according to the proportion γ% to form the selected sample set. Here, the initial sample in the initial sample set can include sample data and a label.

Step 202: Process sample data of each selected sample in the selected sample set to obtain a transform sample set formed by a transform sample with an exogenous feature.

In this embodiment, the sample data of each selected sample in the selected sample set obtained in step 201 can be processed to obtain the transform sample set formed by the transform sample with the exogenous feature. Here, the exogenous feature can be a feature that the sample data of the initial sample in the initial sample set do not have. For an intrinsic feature and an exogenous feature of a sample set, simply speaking, if a sample comes from the data set, a feature that the sample must have is defined as an intrinsic feature. If a sample has an exogenous feature, the sample must not come from this sample set. Specifically, a feature f is referred to as an intrinsic feature in a data set D when and only when sample data randomly obtained from the data set D include the feature f. Similarly, any sample data ( [symbol] , [symbol] ) can be randomly obtained. If the sample data include the feature f, it can be determined that the sample data does not belong to the data set D, and the feature f can be referred to as an exogenous feature of the data set D.

Here, based on a function that can be implemented by a model, the sample data of the initial sample in the initial sample set can be various types of data. For example, when the function implemented by the model is text classification, the sample data of the initial sample can be text information. In this case, the exogenous feature can be a predetermined word, a sentence, etc. in a same language, or can be a predetermined word, a sentence, etc. in another language. In this case, a transform sample with the exogenous feature can be obtained by embedding the exogenous feature into the text information. For another example, when the function implemented by the model is related to voice (for example, voice recognition), the sample data of the initial sample can be voice information. In this case, the exogenous feature can be an unnatural sound such as a specific noise. In this case, a transform sample with the exogenous feature can be obtained by embedding the exogenous feature into the voice information.

In some optional implementations, the model in this embodiment can be an image classification model, the sample data of the initial sample in the initial sample set can be a sample image, and step 202 can be specifically implemented as follows: performing style conversion on a sample image of each sample in the selected sample set by using an image style converter, so the sample image has a specified image style, where the exogenous feature is a feature related to the specified image style.

In this implementation, the image style converter can be a pre-trained machine learning model, used to transform an image into a specified image style. As an example, the specified image style can be a variety of styles, for example, an oil painting style, an ink painting style, a filter effect, mosaic display, etc.

For example, for a predetermined specified style image [symbol] ₛ, the image style converter T can perform style conversion on each selected sample in the selected sample set [symbol] ₛ, so the sample image in the selected sample has a same image style as the specified style image [symbol] ₛ, to obtain the transform sample set. That is, [symbol] ₜ={( [symbol] ′, [symbol] )| [symbol] ′=T( [symbol] , [symbol] ₛ), ( [symbol] , [symbol] )∈ [symbol] ₛ}, where [symbol] ₜ can represent the transform sample set; z,40 , [symbol] respectively indicate the sample data and the label of the selected sample; and [symbol] ′ indicates an image whose style is converted by using the image style converter T and whose style is the same as that of the specified style image [symbol] ₛ. It can be understood that in this implementation, only the style of the sample image of the selected sample is converted, and content of the sample image is not changed. For example, as shown in FIG. 1, a dog is originally displayed in the sample image, and a dog is still displayed after style conversion is performed. Therefore, the label of the selected sample does not need to be changed.

It should be understood that, in this embodiment of this specification, the training data set used by the protected deployment model is required to include the above-mentioned transform sample set, so as to introduce the feature knowledge of the exogenous feature into the deployment model. In addition, it should be understood that the exogenous feature embedded in the above-mentioned implementation has no explicit feature expression, and does not greatly affect prediction of the deployment model trained based on the transform sample set. It can be understood that, in training of the deployment model, transform samples of the transform sample set account for only a small part of total samples. For example, the deployment model can be trained by using the following equation min_{θ} [symbol] [symbol] (V_{θ}( [symbol] ), [symbol] ), where V_{θ} can represent the deployment model, [symbol] ={( [symbol] ᵢ, [symbol] ᵢ)}ᵢ₌₁^{N} can represent the initial sample set, N can represent a quantity of samples, and the sample set [symbol] _{b} [symbol] [symbol] \ [symbol] ₛ can represent a remaining sample set in the initial sample set [symbol] except the selected sample set [symbol] ₛ. [symbol] (⋅) may represent a loss function (for example, cross entropy). Therefore, the deployment model can have the feature knowledge of the exogenous feature.

Step 203: Train a meta-classifier based on a target model, an auxiliary model, and the transform sample set.

In this embodiment, the meta-classifier can be trained based on the target model, the auxiliary model, and the transform sample set. The auxiliary model can be a model trained by using the initial sample set [symbol] , and the target model can be a model trained by using the transform sample set [symbol] ₜ and the remaining sample set in the initial sample set except the selected sample set. The meta-classifier can be used to identify the feature knowledge of the exogenous feature. In practice, the meta-classifier can be a binary classifier.

Step 204: Input related data of a suspicious model into the meta-classifier and determine, based on an output result of the meta-classifier, whether the suspicious model is a model stolen from a deployment model.

In this embodiment, the related data of the suspicious model can be input into the meta-classifier trained in step 203, and it is determined, based on the output result of the meta-classifier, whether the suspicious model is a model stolen from the deployment model. Here, the deployment model can have the feature knowledge of the exogenous feature. As described above, the deployment model can be obtained through training by using the transform sample embedded with the exogenous feature and the initial sample not embedded with the exogenous feature. Therefore, the deployment model can determine the feature knowledge of the exogenous feature. It can be understood that the deployment model can be a model that is deployed online by a model owner for use by a user. As described above, the exogenous feature does not greatly affect prediction of the deployment model. Therefore, the deployment model does not affect normal use of the user. In addition, because the deployment model has the feature knowledge of the exogenous feature, if an attacker obtains, by stealing, an alternative model whose function is similar to that of the deployment model, the alternative model also has the feature knowledge of the exogenous feature. Based on this, if a model is suspected to be an alternative model stolen from the deployment model, the model can be used as a suspicious model for ownership verification. For example, if the model also has the feature knowledge of the exogenous feature, the model can be determined as a model stolen from the deployment model.

In practice, machine learning models of different structures can also implement a same function. Therefore, a model structure of an alternative model obtained by an attacker by stealing the deployment model can be the same as or different from the model structure of the deployment model. That is, the model structure of the suspicious model can be the same as or different from the model structure of the deployment model.

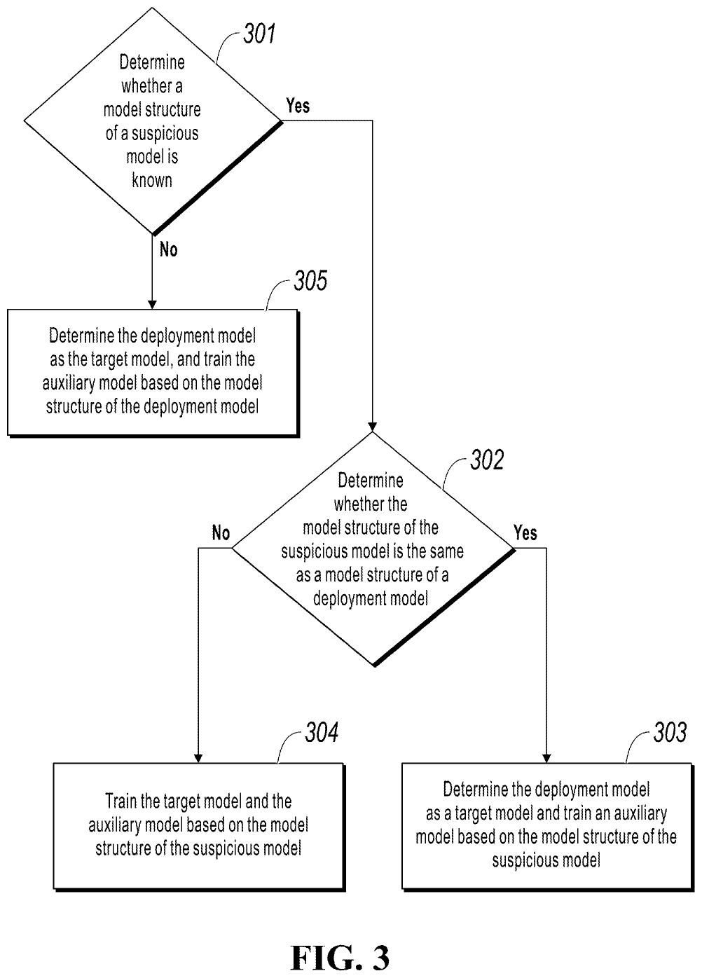

In some optional implementations, before training of the meta-classifier based on the target model, the auxiliary model, and the transform sample set, the method for performing model ownership verification based on an exogenous feature can further include a process of determining the target model and the auxiliary model. For example, multiple scenarios can be classified according to whether the model structure of the suspicious model is known and whether the model structure of the suspicious model is the same as that of the deployment model. As shown in FIG. 3, FIG. 3 is a schematic flowchart of determining a target model and an auxiliary model according to a suspicious model. The method can include the following steps:

Step 301: Determine whether a model structure of a suspicious model is known.

Step 302: In response to determining that the model structure of the suspicious model is known, further determine whether the model structure of the suspicious model is the same as a model structure of a deployment model.

Step 303: Determine the deployment model as a target model and train an auxiliary model based on the model structure of the suspicious model, in response to determining that the model structure of the suspicious model is known and the same as the model structure of the deployment model.

In this implementation, when the model structure of the suspicious model is the same as the model structure of the deployment model, the deployment model can be used as the target model. Therefore, training time of the target model can be reduced. In addition, the auxiliary model that has a same model structure as the target model (the deployment model) and the suspicious model can be trained according to the initial sample in the initial sample set. Because the initial sample in the initial sample set is not embedded with the exogenous feature, the initial sample set can also be referred to as a benign sample set, and the auxiliary model is trained according to the initial sample not embedded with the exogenous feature. Therefore, the auxiliary model can also be referred to as a benign model or a normal model. The auxiliary model does not have the feature knowledge of the exogenous feature.

Step 304: Train the target model and the auxiliary model based on the model structure of the suspicious model, in response to determining that the model structure of the suspicious model is known and different from the model structure of the deployment model.

In this implementation, when the model structure of the suspicious model is different from that of the deployment model, the target model can be trained according to the transform sample set and the remaining sample set in the initial sample set except the selected sample set, and the model structure of the suspicious model. In a training process of the target model, the target model can determine the feature knowledge of the exogenous feature, and has a model structure the same as that of the suspicious model. In addition, the auxiliary model whose structure is the same as that of the suspicious model can be trained according to the initial sample set.

It can be determined from step 303 and step 304 that, if the model structure of the suspicious model is known, the model structures of the target model and the auxiliary model are the same as the model structure of the suspicious model.

Step 305: Determine the deployment model as the target model in response to determining that the model structure of the suspicious model is unknown, and train the auxiliary model based on the model structure of the deployment model.

In this implementation, when the model structure of the suspicious model is unknown, the deployment model can be determined as the target model, and the auxiliary model can be trained according to the initial sample set and the model structure of the deployment model. That is, when the model structure of the suspicious model is unknown, the model structures of the target model and the auxiliary model are the same as the model structure of the deployment model.

In some optional implementations, when the model structure of the suspicious model is known, step 203 of training a meta-classifier based on a target model, an auxiliary model, and the transform sample set can be specifically performed as follows:

First, a first meta-classifier sample set including a positive sample and a negative sample is constructed.

In this implementation, to train a first meta-classifier, the first meta-classifier sample set including the positive sample and the negative sample needs to be constructed first. Here, sample data of the positive sample can be gradient information of the target model for the transform sample. Sample data of the negative sample can be gradient information of the auxiliary model for the transform sample. For example, a gradient vector can be used as the gradient information.

Optionally, the gradient information can alternatively be a result vector obtained after each element in a gradient vector is calculated by using a sign function. The result vector obtained after the gradient vector is calculated by using the sign function is simpler and can still reflect a direction characteristic of a gradient. Therefore, the result vector can be used as the gradient information.

Then, the first meta-classifier sample set is used for training to obtain a binary classifier as the first meta-classifier.

In this implementation, the first meta-classifier sample set can be used for training to obtain the first meta-classifier. Using an example in which a label of the positive sample in the first meta-classifier sample set is +1, a label of the negative sample is −1, and the gradient information is the result vector obtained after each element in the gradient vector is calculated by using the sign function, the first meta-classifier sample set [symbol] _{c} can be represented as [symbol] _{c}= [symbol] ₚₒₛᵢₜᵢᵥₑ∪ [symbol] _{negative}, where the positive sample is [symbol] ₚₒₛᵢₜᵢᵥₑ={(gv( [symbol] ′), +1)|( [symbol] ′, [symbol] )∈ [symbol] ₜ}, and the label in the positive sample is +1; and [symbol] ₜ can represent the transform sample set, and x′ represents the transform sample. Here, gv( [symbol] ′)=sign(∇_{θ} [symbol] (V( [symbol] ′), [symbol] )), where V can represent the target model, gv( [symbol] ′) represents the gradient information of the target model for the transform sample, ∇_{θ} [symbol] (V( [symbol] ′), [symbol] ) represents a loss function gradient vector of the target model for the transform sample, sign(⋅) represent a sign function. The negative sample is [symbol] _{negative}={(g_{B}( [symbol] ′), −1)|( [symbol] ′, [symbol] )∈ [symbol] ₜ}, where the label in the negative sample is −1, where g_{B}( [symbol] ′)=sign(∇_{θ} [symbol] (B( [symbol] ′), [symbol] )), B represents the auxiliary model, g_{B}( [symbol] ′) represents the gradient information of the auxiliary model for the transform sample, and ∇_{θ} [symbol] (B( [symbol] ′), [symbol] ) represents a loss function gradient vector of the auxiliary model for the transform sample. In this example, the first meta-classifier C can be trained by using the following equation

$$\\ {min}_{w} {\sum }_{( x , y ) ∈ {D}_{c}} ℒ ( {C}_{w} ( x ) , y ) ,$$

where w can represent a model parameter in the classifier.

In some optional implementations, when the model structure of the suspicious model is known, step 204 of inputting related data of a suspicious model into the meta-classifier and determining, based on an output result of the meta-classifier, whether the suspicious model is a model stolen from a deployment model can specifically include the following steps 1) to 4):
Step 1): Select the transform sample from the transform sample set as a first transform sample.
Step 2): Determine first gradient information of the suspicious model for the first transform sample.
Step 3): Input the first gradient information into the first meta-classifier to obtain a first prediction result.
Step 4): Determine, in response to the first prediction result indicating a positive sample, that the suspicious model is a model stolen from the deployment model.

For example, the label of the positive sample in the first meta-classifier sample set is +1, the label of the negative sample is −1, and the gradient information is the result vector obtained after each element in the gradient vector is calculated by using the sign function. Assume that the suspicious model is S, the first meta-classifier is C, the first transform sample is a transform image [symbol] ′ whose label is [symbol] , and the first gradient information of the suspicious model for the first transform sample can be determined by using g_{S}( [symbol] ′)=sign(∇_{θ} [symbol] (S( [symbol] ′), [symbol] )). Then, the first gradient information is input to the first meta-classifier C, that is, C(g_{S}( [symbol] ′)), to obtain a first prediction result. If the first prediction result indicates a positive sample, that is, C(g_{S}( [symbol] ′))=1, the suspicious model can be determined as a model stolen from the deployment model. In this example, C(g_{S}( [symbol] ′))=1 can indicate that the suspicious model and the deployment model similarly have the feature knowledge of the exogenous feature, and therefore, the suspicious model can be determined as a model stolen from the deployment model. In this implementation, ownership verification on the suspicious model can be implemented.

In another optional implementation, when the model structure of the suspicious model is known, step 204 of inputting related data of a suspicious model into the meta-classifier and determining, based on an output result of the meta-classifier, whether the suspicious model is a model stolen from a deployment model can further specifically include: using hypothesis testing to validate ownership of the suspicious model based on a first subset selected from the transform sample set, the first meta-classifier, and the auxiliary model.

In this implementation, first a plurality of transform samples can be selected (for example, randomly sampled) from the transform sample set [symbol] ₜ to form a first subset, and then ownership verification on the suspicious model is performed according to the first subset, the first meta-classifier, and the auxiliary model by using a plurality of types of hypothesis testing. For example, a Z-test can be used to perform ownership verification on the suspicious model.

Optionally, the performing ownership verification on the suspicious model by using hypothesis testing can include: performing ownership verification on the suspicious model by using a one-sided paired sample T test, which can specifically include the following content:

First, a first null hypothesis in which a first probability is less than or equal to a second probability is constructed.

In this implementation, for the first subset, the first probability μ_{S} can indicate a posterior probability that a prediction result of the first meta-classifier for gradient information of the suspicious model is a positive sample, and the second probability μ_{B} can indicate a posterior probability that a prediction result of the first meta-classifier for gradient information of the auxiliary model is a positive sample. For example, X′ represents sample data of a transform sample in the first subset, and a label of a positive sample is +1. The first probability μ_{S} and the second probability μ_{B} respectively represent posterior probabilities of events C(g_{S}(X′))=1 and C(g_{B}(X′))=1. A null hypothesis H₀: μ_{S}≤μ_{B} can be constructed for this, where S represents the suspicious model, and B represents the auxiliary model.

Then, a P value is calculated based on the first null hypothesis and sample data in the first subset. It can be understood that, in the one-sided paired sample T test, P value calculation is well known to a person skilled in the art, and details are omitted here for simplicity.

Then, in response to determining that the P value is less than a significance level α, it is determined that the first null hypothesis is rejected. Here, the significance level α can be a value determined by a person skilled in the art according to an actual requirement.

Finally, in response to determining that the first null hypothesis is rejected, the suspicious model is determined as a model stolen from the deployment model. In practice, because the auxiliary model does not have the feature knowledge of the exogenous feature, μ_{B} should be a smaller value. If μ_{S} being less than or equal to μ_{B} is valid, it can indicate that the suspicious model does not have the feature knowledge of the exogenous feature, that is, the suspicious model is not a model stolen from the deployment model. On the contrary, if μ_{S} being less than or equal to μ_{B} is not valid (that is, rejected), it can indicate that the suspicious model has the feature knowledge of the exogenous feature, that is, the suspicious model is a model stolen from the deployment model. In this implementation, ownership verification is performed on the suspicious model by using statistical hypothesis testing, so impact of randomness of transform sample selection in a process of ownership verification on accuracy of ownership verification can be avoided, and verification is more accurate.

As shown in FIG. 3, in some optional implementations, the model structure of the suspicious model is unknown, so it is difficult to obtain gradient information of the model to construct a training sample of the meta-classifier. In this case, step 203 of training a meta-classifier based on a target model, an auxiliary model, and the transform sample set can be specifically performed as follows:

First, a second meta-classifier sample set including a positive sample and a negative sample is constructed.

In this implementation, to train a second meta-classifier, the second meta-classifier sample set including the positive sample and the negative sample needs to be constructed first. Here, sample data of the positive sample are difference information between a prediction output of the target model for a selected sample and a prediction output for a transform sample corresponding to the selected sample. Sample data of the negative sample are difference information between a prediction output of the auxiliary model for a selected sample and a prediction output for a transform sample corresponding to the selected sample. In practice, if the target model and the auxiliary model are classification models, the prediction outputs of the target model and the auxiliary model can be probability vectors respectively formed for a plurality of prediction probabilities of a plurality of category labels. As an example, the difference information can refer to a difference vector. As another example, the difference information can alternatively be a result obtained after the difference vector is calculated by using the sign function. For example, the sample data of the positive sample are sign(V( [symbol] )−V( [symbol] ′)), where V( [symbol] ) represents the prediction output (reflected as a probability vector) of the target model for the selected sample, and V( [symbol] ′) represents the prediction output of the target model for the transform sample corresponding to the selected sample. The sample data of the negative sample are sign(B( [symbol] )−B( [symbol] ′)), where B( [symbol] ) represents the prediction output of the auxiliary model for the selected sample, and B( [symbol] ′) represents the prediction output of the auxiliary model for the transform sample corresponding to the selected sample.

The second meta-classifier sample set is then used to train a second meta-classifier.

In this implementation, the second meta-classifier sample set can be used to train the second meta-classifier. In this implementation, the meta-classifier can be trained when the model structure of the suspicious model is unknown, facilitating subsequent model ownership verification.

In some optional implementations, when the model structure of the suspicious model is unknown, step 204 of inputting related data of a suspicious model into the meta-classifier and determining, based on an output result of the meta-classifier, whether the suspicious model is a model stolen from a deployment model can specifically include the following steps 1 to 4:
Step 1: Respectively obtain a corresponding second transform sample and a corresponding second selected sample from the transform sample set and the selected sample set. Here, that a second transform sample is corresponding to a selected sample can mean that the second transform sample is obtained by embedding the exogenous feature into the selected sample.
Step 2: Determine second difference information between a prediction output of the suspicious model for the second selected sample and a prediction output for the second transform sample.
Step 3: Input the second difference information into the second meta-classifier to obtain a second prediction result.
Step 4: Determine whether the second prediction result indicates a positive sample, and determine, in response to the second prediction result indicating a positive sample, that the suspicious model is a model stolen from the deployment model. In this implementation, ownership verification on the suspicious model can be implemented when the model structure of the suspicious model is unknown.

In another optional implementation, when the model structure of the suspicious model is unknown, step 204 of inputting related data of a suspicious model into the meta-classifier and determining, based on an output result of the meta-classifier, whether the suspicious model is a model stolen from a deployment model can further specifically include: performing ownership verification on the suspicious model by using hypothesis testing based on a second subset selected from the transform sample set, a third subset corresponding to the second subset and in the selected sample set, the second meta-classifier, and the auxiliary model. For example, a Z-test can be used to perform ownership verification on the suspicious model.

Optionally, the performing ownership verification on the suspicious model by using hypothesis testing can include: performing ownership verification on the suspicious model by using a one-sided paired sample T test, which can specifically include the following content:

First, a second null hypothesis in which a third probability is less than or equal to a fourth probability is constructed.

In this implementation, for the second subset and the third subset, the third probability can indicate a posterior probability that a prediction result of the second meta-classifier for the difference information corresponding to the suspicious model is a positive sample. The fourth probability can indicate a posterior probability that a prediction result of the second meta-classifier for the difference information corresponding to the auxiliary model is a positive sample.

Then, a P value is calculated based on the second null hypothesis, sample data of the second subset, and sample data of the third subset. It can be understood that, in the one-sided paired sample T test, P value calculation is well known to a person skilled in the art, and details are omitted here for simplicity.

Then, in response to determining that the P value is less than a significance level α, it is determined that the second null hypothesis is rejected. Here, the significance level α can be a value determined by a person skilled in the art according to an actual requirement.

Finally, in response to determining that the second null hypothesis is rejected, the suspicious model is determined as a model stolen from the deployment model. In practice, because the auxiliary model does not have the feature knowledge of the exogenous feature, the fourth probability should be a smaller value. If the third probability being less than or equal to the fourth probability is valid, it can indicate that the suspicious model does not have the feature knowledge of the exogenous feature, that is, the suspicious model is not a model stolen from the deployment model. On the contrary, if the third probability being less than or equal to the fourth probability is not valid (that is, rejected), it can indicate that the suspicious model has the feature knowledge of the exogenous feature, that is, the suspicious model is a model stolen from the deployment model. In this implementation, ownership verification is performed on the suspicious model by using statistical hypothesis testing, so impact of randomness of transform sample selection in a process of ownership verification on accuracy of ownership verification can be avoided, and verification is more accurate.

According to an embodiment of another aspect, an apparatus for performing model ownership verification based on an exogenous feature is provided. The apparatus for performing model ownership verification based on an exogenous feature can be deployed in any device, platform, or device cluster that has a computing and processing capability.

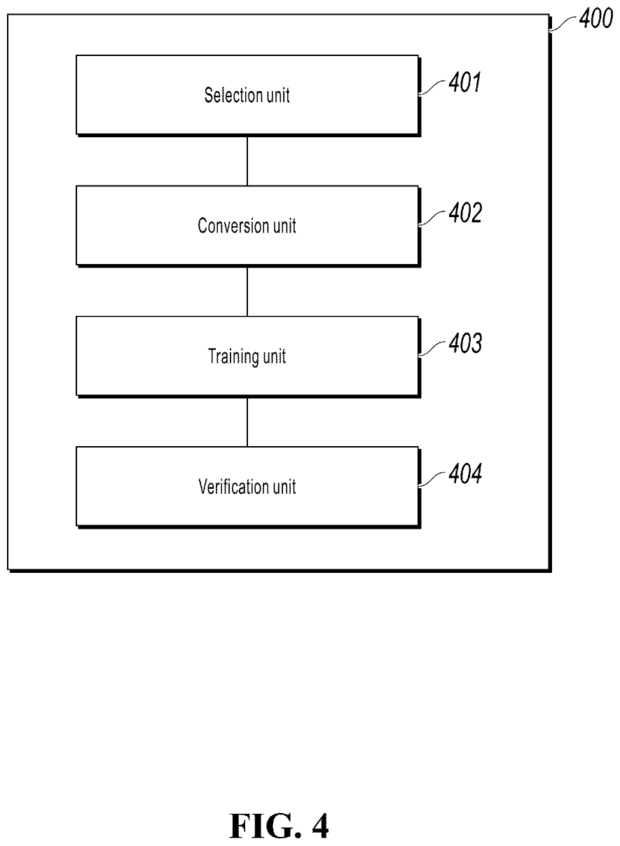

FIG. 4 is a schematic block diagram illustrating an apparatus for performing model ownership verification based on a source feature, according to an embodiment. As shown in FIG. 4, the apparatus 400 for performing model ownership verification based on a source feature includes: a selection unit 401, configured to select some initial samples from an initial sample set to form a selected sample set; a transform unit 402, configured to process sample data of each selected sample in the selected sample set to obtain a transform sample set formed by a transform sample with an exogenous feature, where the exogenous feature is a feature that sample data of the initial sample do not have; a training unit 403, configured to train a meta-classifier based on a target model, an auxiliary model, and the transform sample set, where the auxiliary model is a model trained by using the initial sample set, the target model is a model trained by using the transform sample set and a remaining sample set in the initial sample set except the selected sample set, and the meta-classifier is used to identify feature knowledge of the exogenous feature; and a verification unit 404, configured to input related data of a suspicious model into the meta-classifier and determine, based on an output result of the meta-classifier, whether the suspicious model is a model stolen from a deployment model, where the deployment model has feature knowledge of the exogenous feature.

In some optional implementations of this embodiment, the apparatus 400 further includes: a first model training unit (not shown in the figure), configured to determine the deployment model as the target model and train the auxiliary model based on a model structure of the suspicious model, in response to the model structure of the suspicious model being known and the same as a model structure of the deployment model; and a second model training unit (not shown in the figure), configured to train the target model and the auxiliary model based on the model structure of the suspicious model, in response to the model structure of the suspicious model being known and different from the model structure of the deployment model.

In some optional implementations of this embodiment, the training unit 403 is further configured to: construct a first meta-classifier sample set including a positive sample and a negative sample, where sample data of the positive sample are gradient information of the target model for the transform sample; and sample data of the negative sample are gradient information of the auxiliary model for the transform sample; and train to obtain a first meta-classifier by using the first meta-classifier sample set.

In some optional implementations of this embodiment, the gradient information is a result vector obtained after each element in a gradient vector is calculated by using a sign function.

In some optional implementations of this embodiment, the verification unit 404 is further configured to: select a first transform sample from the transform sample set; determine first gradient information of the suspicious model for the first transform sample; input the first gradient information into the first meta-classifier to obtain a first prediction result; and determine, in response to the first prediction result indicating a positive sample, that the suspicious model is a model stolen from the deployment model.

In some optional implementations of this embodiment, the verification unit 404 is further configured to: use hypothesis testing to validate ownership of the suspicious model based on a first subset selected from the transform sample set, the first meta-classifier, and the auxiliary model.

In some optional implementations of this embodiment, the using hypothesis testing to validate ownership of the suspicious model includes: constructing a first null hypothesis in which a first probability is less than or equal to a second probability, where the first probability indicates a posterior probability that a prediction result of the first meta-classifier for gradient information of the suspicious model is a positive sample, and the second probability indicates a posterior probability that a prediction result of the first meta-classifier for gradient information of the auxiliary model is a positive sample; calculating a P value based on the first null hypothesis and sample data in the first subset; determining, in response to determining that the P value is less than a significance level α, that the first null hypothesis is rejected; and determining, in response to determining that the first null hypothesis is rejected, that the suspicious model is a model stolen from the deployment model.

In some optional implementations of this embodiment, the apparatus 400 further includes: a third model training unit (not shown in the figure), configured to: determine the deployment model as the target model in response to a model structure of the suspicious model being unknown, and train the auxiliary model based on a model structure of the deployment model.

In some optional implementations of this embodiment, the training unit 403 is further configured to: construct a second meta-classifier sample set including a positive sample and a negative sample, where sample data of the positive sample are difference information between a prediction output of the target model for a selected sample and a prediction output for a transform sample corresponding to the selected sample; and sample data of the negative sample are difference information between a prediction output of the auxiliary model for a selected sample and a prediction output for a transform sample corresponding to the selected sample; and train a second meta-classifier by using the second meta-classifier sample set.

In some optional implementations of this embodiment, the verification unit 404 is further configured to: respectively obtain a corresponding second transform sample and a corresponding second selected sample from the transform sample set and the selected sample set; determine second difference information between a prediction output of the suspicious model for the second selected sample and a prediction output for the second transform sample; input the second difference information into the second meta-classifier to obtain a second prediction result; and determine, in response to the second prediction result indicating a positive sample, that the suspicious model is a model stolen from the deployment model.

In some optional implementations of this embodiment, the verification unit 404 is further configured to: perform ownership verification on the suspicious model by using hypothesis testing based on a second subset selected from the transform sample set, a third sub set corresponding to the second subset and in the selected sample set, the second meta-classifier, and the auxiliary model.

In some optional implementations of this embodiment, the using hypothesis testing to validate ownership of the suspicious model includes: constructing a second null hypothesis in which a third probability is less than or equal to a fourth probability, where the third probability indicates a posterior probability that a prediction result of the second meta-classifier for difference information corresponding to the suspicious model is a positive sample, and the fourth probability indicates a posterior probability that a prediction result of the second meta-classifier for difference information corresponding to the auxiliary model is a positive sample; calculating a P value based on the second null hypothesis, sample data of the second subset, and sample data of the third subset; determining, in response to determining that the P value is less than a significance level α, that the second null hypothesis is rejected; and determining, in response to determining that the second null hypothesis is rejected, that the suspicious model is a model stolen from the deployment model.

In some optional implementations of this embodiment, the sample data of the initial sample in the initial sample set are a sample image; and the transform unit 402 is further configured to: perform style conversion on a sample image of each sample in the selected sample set by using an image style converter, so the sample image has a specified image style, where the exogenous feature is a feature related to the specified image style.

According to some embodiments in another aspect, a computer-readable storage medium is further provided, where the computer-readable storage medium stores a computer program, and when the computer program is executed in a computer, the computer is enabled to perform the method described in FIG. 2.

In one or more embodiments of still another aspect, a computing device is further provided, including a memory and a processor. The memory stores executable code, and when executing the executable code, the processor implements the method the method described in FIG. 2.

A person of ordinary skill in the art can be further aware that, in combination with the examples described in the implementations disclosed in this specification, units and algorithm steps can be implemented by electronic hardware, computer software, or a combination thereof. To clearly describe interchangeability between the hardware and the software, compositions and steps of each example are generally described above based on functions. Whether the functions are performed by hardware or software depends on particular applications and design constraint conditions of the technical solutions. A person of ordinary skill in the art can use different methods to implement the described functions for each particular application, but it should not be considered that the implementation goes beyond the scope of this application.

Steps of methods or algorithms described in the implementations disclosed in this specification can be implemented by hardware, a software module executed by a processor, or a combination thereof. The software module can reside in a random access memory (RAM), a memory, a read-only memory (ROM), an electrically programmable ROM, an electrically erasable programmable ROM, a register, a hard disk, a removable disk, a CD-ROM, or any other form of storage medium known in the art.

In the described specific implementations, the objective, technical solutions, and benefits of the present disclosure are further described in detail. It should be understood that the descriptions are merely specific implementations of the present disclosure, but are not intended to limit the protection scope of the present disclosure. Any modification, equivalent replacement, or improvement made without departing from the spirit and principle of the present disclosure should fall within the protection scope of the present disclosure.

1. A computer-implemented method comprising:
selecting initial samples from an initial sample set to form a selected sample set;
processing sample data of the initial samples to obtain transform samples that form a transform sample set, wherein each of the transform samples comprises an exogenous feature absent from sample data of the initial samples;
training a meta-classifier based on a target model, an auxiliary model, and the transform sample set, wherein the auxiliary model is trained by using the initial sample set, the target model is trained by using the transform sample set and a remaining sample set formed by samples in the initial sample set other than the selected sample set, and the meta-classifier identifies feature knowledge of the exogenous feature;
inputting data associated with a suspicious model into the meta-classifier; and
determining, based on an output result of the meta-classifier, whether the suspicious model is stolen from a deployment model, wherein the deployment model has feature knowledge of the exogenous feature.

2. The computer-implemented method according to claim 1, wherein before the training a meta-classifier, the computer-implemented method further comprises:
determining the deployment model as the target model;
determining whether a model structure of the suspicious model is same as a model structure of the deployment model; and
in response to determining that the suspicious model is the same as the model structure of the deployment model, training the auxiliary model based on the model structure of the suspicious model; or
in response to determining that the model structure of the suspicious model is different from the model structure of the deployment model, training the target model and the auxiliary model based on the model structure of the suspicious model.

3. The computer-implemented method according to claim 2, wherein the training a meta-classifier comprises:
constructing a first meta-classifier sample set comprising a positive sample and a negative sample, wherein sample data of the positive sample are gradient information of the target model for the transform sample, and sample data of the negative sample are gradient information of the auxiliary model for the transform sample; and
training to obtain a first meta-classifier by using the first meta-classifier sample set.

4. The computer-implemented method according to claim 3, wherein the gradient information is a result vector obtained after each element in a gradient vector is calculated by using a sign function.

5. The computer-implemented method according to claim 3, wherein the inputting related data of a suspicious model into the meta-classifier comprises:
selecting a first transform sample from the transform sample set;
determining first gradient information of the suspicious model for the first transform sample; and
inputting the first gradient information into the first meta-classifier to obtain a first prediction result; and wherein
the determining whether the suspicious model is stolen from a deployment model comprises:
determining that the suspicious model is stolen from the deployment model in response to the first prediction result indicating a positive sample.

6. The computer-implemented method according to claim 3, wherein the determining whether the suspicious model is stolen from a deployment model comprises:
using hypothesis testing to validate ownership of the suspicious model based on a first subset selected from the transform sample set, the first meta-classifier, and the auxiliary model.

7. The computer-implemented method according to claim 6, wherein the using hypothesis testing to validate ownership of the suspicious model comprises:
constructing a first null hypothesis in which a first probability is less than or equal to a second probability, wherein the first probability indicates a posterior probability that a prediction result of the first meta-classifier for gradient information of the suspicious model is a positive sample, and the second probability indicates a posterior probability that a prediction result of the first meta-classifier for gradient information of the auxiliary model is a positive sample;
calculating a P value based on the first null hypothesis and sample data in the first subset;
determining, in response to determining that the P value is less than a significance level α, that the first null hypothesis is rejected; and
determining, in response to determining that the first null hypothesis is rejected, that the suspicious model is stolen from the deployment model.

8. The computer-implemented method according to claim 1, wherein before the training a meta-classifier based on a target model, an auxiliary model, and the transform sample set, the computer-implemented method further comprises:
determining the deployment model as the target model in response to determining that a model structure of the suspicious model is unknown; and
training the auxiliary model based on a model structure of the deployment model.

9. The computer-implemented method according to claim 8, wherein the training a meta-classifier based on a target model, an auxiliary model, and the transform sample set comprises:
constructing a second meta-classifier sample set comprising a positive sample and a negative sample, wherein sample data of the positive sample comprises difference information between a prediction output of the target model for a selected sample and a prediction output for a transform sample corresponding to the selected sample, and wherein sample data of the negative sample comprises difference information between a prediction output of the auxiliary model for a selected sample and a prediction output for a transform sample corresponding to the selected sample; and
training a second meta-classifier by using the second meta-classifier sample set.

10. The computer-implemented method according to claim 9, wherein the inputting related data of a suspicious model into the meta-classifier comprises:
obtaining a corresponding second transform sample and a corresponding second selected sample from the transform sample set and the selected sample set;
determining second difference information between a prediction output of the suspicious model for the corresponding second selected sample and a prediction output for the corresponding second transform sample; and
inputting the second difference information into the second meta-classifier to obtain a second prediction result; and wherein
the determining whether the suspicious model is stolen from a deployment model comprises:
determining, in response to the second prediction result indicating a positive sample, that the suspicious model is a model stolen from the deployment model.

11. The computer-implemented method according to claim 9, wherein determining whether the suspicious model is stolen from a deployment model comprises:
performing ownership verification on the suspicious model by using hypothesis testing based on a second subset selected from the transform sample set, a third subset corresponding to the second subset and in the selected sample set, the second meta-classifier, and the auxiliary model.

12. The computer-implemented method according to claim 11, wherein the using hypothesis testing to validate ownership of the suspicious model comprises:
constructing a second null hypothesis in which a third probability is less than or equal to a fourth probability, wherein the third probability indicates a posterior probability that a prediction result of the second meta-classifier for difference information corresponding to the suspicious model is a positive sample, and the fourth probability indicates a posterior probability that a prediction result of the second meta-classifier for difference information corresponding to the auxiliary model is a positive sample;
calculating a P value based on the second null hypothesis, sample data of the second subset, and sample data of the third subset;
determining that the second null hypothesis is rejected in response to determining that the P value is less than a significance level α; and
determining that the suspicious model is stolen from the deployment model in response to determining that the second null hypothesis is rejected.

13. The computer-implemented method according to claim 1, wherein the sample data of the initial samples in the initial sample set are sample images, and wherein the processing sample data of the initial samples comprises:
performing style conversion on sample images of the initial samples in the selected sample set by using an image style converter to obtain a specified image style, wherein the exogenous feature is related to the specified image style.

14. A non-transitory, computer-readable medium storing one or more instructions executable by a computer system to perform operations comprising:
selecting initial samples from an initial sample set to form a selected sample set;
processing sample data of the initial samples to obtain transform samples that form a transform sample set, wherein each of the transform samples comprises an exogenous feature absent from sample data of the initial samples;
training a meta-classifier based on a target model, an auxiliary model, and the transform sample set, wherein the auxiliary model is trained by using the initial sample set, the target model is trained by using the transform sample set and a remaining sample set formed by samples in the initial sample set other than the selected sample set, and the meta-classifier identifies feature knowledge of the exogenous feature;
inputting data associated with a suspicious model into the meta-classifier; and
determining, based on an output result of the meta-classifier, whether the suspicious model is stolen from a deployment model, wherein the deployment model has feature knowledge of the exogenous feature.

15. The non-transitory, computer-readable medium according to claim 14, wherein before the training a meta-classifier, the operations further comprise:
determining the deployment model as the target model;
determining whether a model structure of the suspicious model is same as a model structure of the deployment model; and
in response to determining that the suspicious model is the same as the model structure of the deployment model, training the auxiliary model based on the model structure of the suspicious model; or
in response to determining that the model structure of the suspicious model is different from the model structure of the deployment model, training the target model and the auxiliary model based on the model structure of the suspicious model.

16. The non-transitory, computer-readable medium according to claim 15, wherein the training a meta-classifier comprises:
constructing a first meta-classifier sample set comprising a positive sample and a negative sample, wherein sample data of the positive sample are gradient information of the target model for the transform sample, and sample data of the negative sample are gradient information of the auxiliary model for the transform sample; and
training to obtain a first meta-classifier by using the first meta-classifier sample set.

17. The non-transitory, computer-readable medium according to claim 16, wherein the gradient information is a result vector obtained after each element in a gradient vector is calculated by using a sign function.

18. The non-transitory, computer-readable medium according to claim 16, wherein the inputting related data of a suspicious model into the meta-classifier comprises:
selecting a first transform sample from the transform sample set;
determining first gradient information of the suspicious model for the first transform sample; and
inputting the first gradient information into the first meta-classifier to obtain a first prediction result; and wherein
the determining whether the suspicious model is stolen from a deployment model comprises:
determining that the suspicious model is stolen from the deployment model in response to the first prediction result indicating a positive sample.

19. The non-transitory, computer-readable medium according to claim 16, wherein the determining whether the suspicious model is stolen from a deployment model comprises:
using hypothesis testing to validate ownership of the suspicious model based on a first subset selected from the transform sample set, the first meta-classifier, and the auxiliary model.

20. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
selecting initial samples from an initial sample set to form a selected sample set;
processing sample data of the initial samples to obtain transform samples that form a transform sample set, wherein each of the transform samples comprises an exogenous feature absent from sample data of the initial samples;
training a meta-classifier based on a target model, an auxiliary model, and the transform sample set, wherein the auxiliary model is trained by using the initial sample set, the target model is trained by using the transform sample set and a remaining sample set formed by samples in the initial sample set other than the selected sample set, and the meta-classifier identifies feature knowledge of the exogenous feature;
inputting data associated with a suspicious model into the meta-classifier; and
determining, based on an output result of the meta-classifier, whether the suspicious model is stolen from a deployment model, wherein the deployment model has feature knowledge of the exogenous feature.
